(19) United States
(12) Patent Application Publication
(10) Pub. No.: US 2007/0015070 A1
(43) Pub. Date: Jan. 18, 2007

(54) Manufacturing apparatus for oriented film, liquid crystal device, and electronic device

(75) Inventors: Hideo Nakata, Suwa (JP); Takuya Miyakawa, Okaya (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/484,530

(22) Filed: Jul. 11, 2006

(30) Foreign Application Priority Data
Jul. 14, 2005 (JP) 2005-205469

(51) Int. Cl. C09K 19/00

(52) U.S. Cl. 430/20

(57) ABSTRACT

A manufacturing apparatus for manufacturing an oriented film, comprising: a film formation chamber; an evaporation section having an evaporation source, evaporating an oriented film material on the substrate by a physical vapor deposition, and forming the oriented film in the film formation chamber; a shielding plate arranged between the evaporation section and the substrate, having an elongated opening for selectively evaporating the oriented film material, and covering an area of the substrate on which the oriented film is not formed; a transfer chamber connected to the film formation chamber via a gate valve; a storing chamber connected to the transfer chamber and storing an unused shielding plate; and a substituting device arranged in the transfer chamber and substituting the shielding plate arranged in the film formation chamber to the unused shielding plate stored in the storing chamber.

### CROSS-REFERENCE TO RELATED APPLICATION

This application claims priority on Japanese Patent Application No. 2005-205469, filed Jul. 14, 2005, the contents of which are incorporated herein by reference.

### BACKGROUND

1. Technical Field

The present invention relates to a manufacturing apparatus for an oriented film, a liquid crystal device, and an electronic device.

2. Related Art

A liquid crystal device has been used as a photo-modulation section in a projection display device such as a liquid crystal projector, etc.

Such a liquid crystal device includes a sealant arranged at the periphery between a pair of substrates and a liquid crystal layer sealed at its center.

Electrodes for applying a voltage to the liquid crystal layer are formed on the side of an inner surface of the pair of substrates, and an oriented film for controlling the orientation of liquid crystal molecules when applying a non-selective voltage is formed on the side of the inner surface of the electrodes.

By such a constitution, the liquid crystal device modulates the light of a light source based on the orientation change of the liquid crystal molecules when applying a non-selective voltage or selective voltage to form the light of an image.

An oriented film subjected to a rubbing treatment is generally used as the above-mentioned oriented film on the surface of a polymer film made of polyimides to which a side-chain alkyl group, etc, has been added.

The rubbing treatment section of a polymer is oriented in a predetermined direction by rubbing the surface of a polymer film in a predetermined direction with a roller having a soft cloth.

Liquid crystal molecules are arranged along an orienting high polymer due to an intermolecular interaction between the orienting high molecules and the liquid crystal molecules.

Therefore, liquid crystal molecules can be oriented in a predetermined direction, when a non-selective voltage is applied.

A pre-tilt can be given to a liquid crystal molecule by a side-chain alkyl group.

However, when a liquid crystal device fitted with such an organic oriented film is adopted as the photo-modulation section of a projector, there is concern that the oriented film will gradually degrade due to strong light radiated from a light source or heat.

There is further concern that the orientation control function of liquid crystal molecules is reduced and the display quality of the liquid crystal projector will deteriorate after extended use, e.g., the liquid crystal molecules cannot be arrayed at a desired pre-tilt angle.

Accordingly, the use of an oriented film made of an inorganic material excellent in light resistance and heat resistance has been proposed.

As a manufacturing method for such an inorganic oriented film, for example, a silicon oxide (SiO₂) film formed by an oblique evaporation process is known.

When an inorganic oriented film is formed by the oblique evaporation process, it is necessary to control the incidence angle of an oriented film material to form the oriented film in a desired oriented state.

As a technique for controlling the incidence angle of an orientation material, Japanese Unexamined Patent Application, First Publication No. 2002-365639 is known.

According to this technique, a shielding plate having a slit is arranged between an oriented film material and a substrate, through which a desired oriented film is formed by selective evaporation at a predetermined incidence angle.

However, in the above described technique, the oriented film material is evaporated not only on the substrate but also on the shielding plate, so that a width of the slit of the shielding plate is narrowed after extended evaporating.

By this means, an evaporating condition including the incidence angle regulated by the slit of the shielding plate is changed compared with an initial evaporating condition, irregularities of evaporation or the like occurr, and a desired oriented film cannot be obtained.

Furthermore, the oriented film material is adhered in the vicinity of the slit of the shielding plate. If the evaporating is continued in this state, adherent evaporants become floatable particles and adhere to the oriented film. There is concern that the film performance such as the orientation control function is degraded because of this.

To avoid such a disadvantage, it is necessary to frequently perform maintenance on the inside of the apparatus such as changing the shielding plate. However, in this case, there is a new disadvantage such that productivity is lowered.

This is because no matter how the evaporation is performed in a vacuum, when maintenance for the inside of the apparatus is performed, it is necessary to adjust the pressure inside the apparatus from a vacuum to an atmospheric pressure.

Therefore, it is necessary to set a desired pressure by exhausting the air from the inside of the apparatus for performing the evaporation again after maintenance.

However, exhausting the inside of the apparatus takes time. For example, in the case of evaporating a large substrate from which a plurality of substrates is taken, the evaporating apparatus must be large, and there is a substantial need for ten hours to one day to exhaust the air from the inside of the evaporating apparatus.

### SUMMARY

An advantage of some aspects of the invention is to provide a manufacturing apparatus for an oriented film, a liquid crystal device and electronic device which improve the productivity of the manufacturing of the oriented film, and. which prevent the degradation of the film performance such as the orientation control function of the oriented film.

A first aspect of the invention provides a manufacturing apparatus for manufacturing an oriented film of a liquid crystal device holding a liquid crystal between a pair of substrates facing each other, including: a film formation chamber constituted as a vacuum chamber; an evaporation section having an evaporation source, evaporating an oriented film material on the substrate by a physical vapor deposition, and forming the oriented film in the film formation chamber; a shielding plate arranged between the evaporation section and the substrate, having an elongated opening for selectively evaporating the oriented film material, and covering an area of the substrate on which the oriented film is not formed; a transfer chamber constituted as a vacuum chamber and connected to the film formation chamber via a gate valve; a storing chamber connected to the transfer chamber and storing an unused shielding plate (reserved shielding plate); and a substituting device arranged in the transfer chamber and substituting the shielding plate arranged in the film formation chamber to the unused shielding plate stored in the storing chamber.

According to this manufacturing apparatus, it is possible to substitute the shielding plate with an unused shielding plate by the substituting device and by adjusting the pressure of the transfer chamber in a vacuum while maintaining the pressure of the film formation chamber in a vacuum, when maintenance for the apparatus is performed, for example, after evaporation is performed in a predetermined period.

Therefore, it is possible to reset the evaporating condition to an initial evaporating condition by substituting the shielding plate with the new shielding plate, and to prevent the degradation of the film performance such as the orientation control function of the oriented film.

Furthermore, it is possible to prevent the occurrence of evaporation irregularities such as line-like marks or the like that are formed on the manufactured oriented film due to the influence of the oriented film material adhered to the shielding plate. In addition, it is possible to also prevent the adhering of floatable particles adhered on the shielding plate to the oriented film.

Thus, the degradation of the film performance such as the orientation control function of the manufactured oriented film can be prevented.

In the above-described maintenance, since the substituting of the shielding plate can be performed while maintaining the inside of the film formation chamber in a vacuum state, it is possible to omit the operation of reverting the pressure inside the film formation chamber from the vacuum to the atmospheric pressure, and next adjusting the pressure from the atmospheric pressure to the vacuum.

Therefore, it is possible to remarkably improve productivity by avoiding the operation of reverting the pressure in the vacuum.

It is preferable that, in the manufacturing apparatus for manufacturing the oriented film of the first aspect of the invention, the storing chamber be connected to the transfer chamber via a gate valve.

In this manner, it is possible to substitute the shielding plate stored in the storing chamber while maintaining the transfer chamber in a vacuum by closing the gate valve, after all of the unused shielding plates stored in the storing chamber are used for the evaporation.

Furthermore, the transfer chamber is maintained in a vacuum such as described above so that it is possible to prevent increasing the pressure of the film formation chamber, when the film formation chamber is communicatively connected to the transfer chamber for maintenance.

It is preferable that, in the manufacturing apparatus for manufacturing the oriented film of the first aspect of the invention, the substituting device include: a discharging arm mechanism discharging the shielding plate from the film formation chamber to the storing chamber; and a supplying arm mechanism supplying the unused shielding plate from the storing chamber to the film formation chamber.

In this manner, since it is possible to discharge the used shielding plate from the film formation chamber to the storing chamber, and supply the unused shielding plate from the storing chamber to the film formation chamber in parallel, the time needed for the substituting of the shielding plate can be shortened. Thus, productivity can be remarkably improved.

It is preferable that the manufacturing apparatus for manufacturing the oriented film of the first aspect of the invention further include: a plurality of the transfer chambers; and a plurality of the storing chambers.

In this manner, the used shielding plate is discharged from the inside of the film formation chamber to the storing chamber via one transfer chamber (first transfer chamber). Also, the unused shielding plate is supplied from the storing chamber to the film formation chamber via the other transfer chamber (second transfer chamber) in parallel transferring.

Therefore, the time needed for substituting of the shielding plate can be shortened. Thus, productivity can be remarkably improved.

Furthermore, in the case in which, for example, a plurality of the shielding plates are substituted in the film formation chamber,. the transfer chambers and the storing chambers are provided to the manufacturing apparatus so that it is possible to simultaneously substitute these shielding plates.

It is preferable that, in the manufacturing apparatus for manufacturing the oriented film of the first aspect of the invention, at least one of the substituting devices be arranged in the transfer chamber.

In this manner, since it is possible to discharge the used shielding plate from the film formation chamber to the storing chamber, and supply the unused shielding plate from the storing chamber to the film formation chamber in parallel, the time needed for the substituting of the shielding plate can be shortened. Thus, productivity can be remarkably improved.

It is preferable that, in the manufacturing apparatus for manufacturing the oriented film of the first aspect of the invention, a plurality of the shielding plates be arranged in the film formation chamber.

In this manner, it is possible to simultaneously or intermittently perform the evaporation on each of the substrates to which each of the shielding plates corresponds. Thus, it is possible to further realize an improvement in productivity.

It is preferable that the manufacturing apparatus for manufacturing the oriented film of the first aspect of the invention further include: a holding section arranged in the film formation chamber and holding the shielding plate; an alignment section arranged between the holding section and the shielding plate, and aligning the shielding plate so as to position the elongated opening of the shielding plate at a predetermined position.

In this manner, it is possible to easily align and to easily set the shielding plate so as to set the position of opening of the shielding plate to the predetermined position, when the shielding plate is substituted.

It is preferable that, in the manufacturing apparatus for manufacturing the oriented film of the first aspect of the invention, the evaporation section have a shutter openably and closably covering the evaporation source.

There is concern that, when the oriented film material is sublimated by the evaporation section, the sublimation rate of the evaporation source is not stabilized in the initial stage of sublimation of the oriented film material. Thus irregularities of the oriented film obtained by the evaporation occur in the initial stage of the evaporation.

Accordingly, it is possible to stop the evaporation until the sublimation rate of the evaporation source stabilizes by the opening and closing shutter covering the evaporation source in the initial stage of sublimation of the oriented film material.

Furthermore, it is possible to prevent the adherence of the oriented film material on the inside wall of the film formation chamber by covering the evaporation source such as above.

However, with respect to the shutter, the amount of the adherence of the oriented film material to the shutter increases when using the shutter for a long time, so there is concern that adherent evaporants become floatable particles and adhere to the oriented film. Therefore, the film performance such as the orientation control function of the oriented film is degraded.

Accordingly, similar to the case of the substitute and the transport of the shielding plate, it is preferable that the manufacturing apparatus for manufacturing the oriented film, further include: a transfer chamber transporting the shutter; and a substituting device formed in the transfer chamber and substituting the shutter, where the substituting of the shutter be automatically performed without changing the vacuum state of the film formation chamber.

A second aspect of the invention provides a liquid crystal device including the oriented film manufactured by the above-described manufacturing apparatus.

With respect to the liquid crystal device, since the degradation of the film performance such as the orientation control function of the oriented film can be prevented as described above, the liquid crystal device itself also has desirable qualities.

Furthermore, since the productivity of manufacturing the oriented film can be improved, productivity of manufacturing the liquid crystal device can be also improved.

A third aspect of the invention provides an electronic device including the above-described liquid crystal device.

Thus, since the electronic device includes the liquid crystal device having desirable qualities and improved productivity, the electronic device itself also has desirable qualities and the productivity of the electronic device is improved.

### BRIEF DESCRIPTION OF THE DRAWINGS

FIG. 1 is a schematic block diagram of an embodiment of the manufacturing apparatus of this invention.

FIG. 2 is a plan view for describing a shielding plate and a holding section.

FIG. 3 is a cross-sectional view for describing the shielding plate on which an oriented film material is adhered.

FIG. 4 is a schematic plan view of the manufacturing apparatus including the shielding plates.

FIG. 5 is a plan view of a TFT array substrate of a liquid crystal device.

FIG. 6 is an equivalent circuit diagram of the liquid crystal device.

FIG. 7 is a plan view showing a structure of the liquid crystal device.

FIG. 8 is a cross-sectional view showing a structure of the liquid crystal device for describing the liquid crystal device.

FIG. 9 is a schematic block diagram showing a projector.

### DESCRIPTION OF EXEMPLARY EMBODIMENTS

The invention is described in detail hereinafter with reference to the drawings.

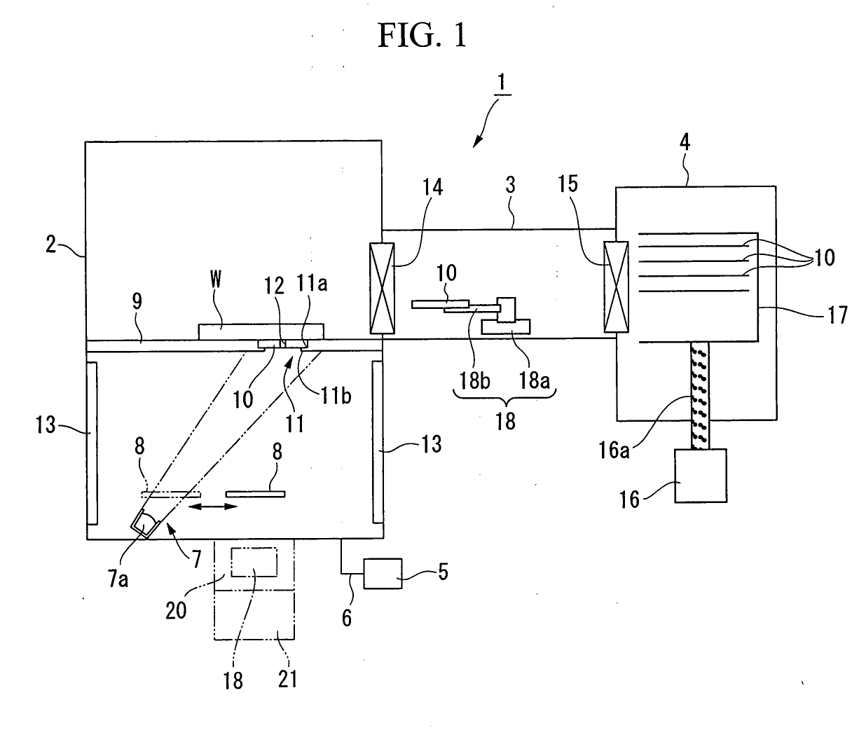

FIG. 1 is a cross-sectional view of an embodiment of the manufacturing apparatus of this invention.

In FIG. 1, reference numeral 1 represents a manufacturing apparatus for manufacturing an oriented film (hereinafter referred to as the manufacturing apparatus).

The manufacturing apparatus 1 forms an oriented film made of an inorganic material on the surface of a substrate W constituting a constituent member of the liquid crystal device.

The manufacturing apparatus 1 includes a film formation chamber 2 constituted as a vacuum chamber, a transfer chamber 3 constituted as a vacuum chamber connected to the film formation chamber 2, and a storing chamber 4 connected to the transfer chamber 3 and in which unused shielding plates are stored.

The film formation chamber 2 communicates with a pre-processing chamber (not shown) in which the substrate W is subjected to a pretreatment for the forming of the oriented film (e.g., heating treatment for substrate W) and with a post-processing chamber (not shown) in which the substrate W is subjected to an after-treatment for the forming of the oriented film (e.g., cooling treatment for substrate W).

Gate valves tightly isolating the film formation chamber 2 from the pre-processing chamber and from the post-processing chamber are provided.

In this a constitution, it is possible to transfer the substrates W from the pre-processing chamber to the film formation chamber 2, and is possible to transfer the substrates W from the film formation chamber 2 to the post-processing chamber, without greatly lowering the vacuum in the film formation chamber 2.

A transporting section (not shown) is connected to the film formation chamber 2. The transporting section receives the substrate W from the pre-processing chamber, continuously or intermittently transports the substrates W in the film formation chamber 2, and sends the substrates W out from the film formation chamber 2 toward the post-processing chamber.

A vacuum pump 5 for controlling the inner pressure to obtain a desired vacuum state is connected to the film formation chamber 2 via a pipe 6.

The evaporating section 7 is arranged at the bottom of the film formation chamber 2 and at the side of the inner wall of the film formation chamber 2.

The evaporating section 7 evaporates the inorganic material, which becomes the oriented film material on the substrates W by a physical vapor deposition process, i.e., an evaporation process or a sputtering process such as an ion beam sputtering process, etc. to form the oriented film.

In this embodiment, the evaporating section 7 includes an evaporation source 7a made of the inorganic material and an electron beam gun unit (not shown) which radiates an electron beam onto the evaporation source 7a to heat and sublimate the inorganic material.

Here, silicon oxide (SiOx) such as silicon dioxide (SiO₂) or the like, or metal oxides (such as Al₂O₃, ZnO, MgO, ITO, etc.) is used as the inorganic material and becomes the oriented film material in this embodiment.

In the evaporating section 7, the opening of a crucible (not shown) holding the evaporation source 7a is arranged so as to face an opening of the shielding plate as described later, thereby the evaporating section 7 efficiently sublimates and deposits an evaporant of the oriented film material to the vicinity of the opening of the shielding plate and in a direction shown by a double chain line in FIG. 1.

The evaporating section 7 includes an openable and closable shutter 8 covering the evaporation source 7a.

In this embodiment, the shutter 8 is connected to a forward/backward mechanism (not shown), and is possible to cover the evaporation source 7a (state shown by a solid line in FIG. 1) and to open the evaporation source 7a (state shown by a double chain line in FIG. 1).

Therefore, the forming of film on the substrates W can be stopped until the sublimation rate of the evaporation source 7a stabilizes by closing the shutter 8 and by covering the evaporation source 7a, especially in the initial stage of sublimation of an orientation material, as described later.

A holding plate 9 is formed between the evaporating section 7 and the substrate W. The holding plate 9 holds the substrate W on or above the upper face of the holding plate 9, and allows the substrate W to be movable as shown by the transporting section (not shown).

A holding section 11 holding a shielding plate 10 is formed on the holding plate 9. The holding section 11 is positioned at a side of an inner wall opposite of which the evaporating section 7 is arranged.

The holding section 11 includes an opening 11a and a holding portion 11b.

The opening 11a is shaped to correspond to the shape of the shielding plate 10.

The holding portion 11b extends from a wall of the opening 11a to the inside of the opening 11a, and is formed in the opening 11a of the holding plate 9.

By this means, the shielding plate 10 is attachably/detachably held and fixed on the holding plate 9 while the shielding plate 10 is fit into the opening 11a and is mounted on the holding portion 11b.

The shielding plate 10 is made of a metal, ceramic, resin, or the like.

The shielding plate 10 is held and fixed in the holding section 1 of the holding plate 9 thereby the shielding plate 10 covers a non-oriented film formation area of the substrate W, as described later.

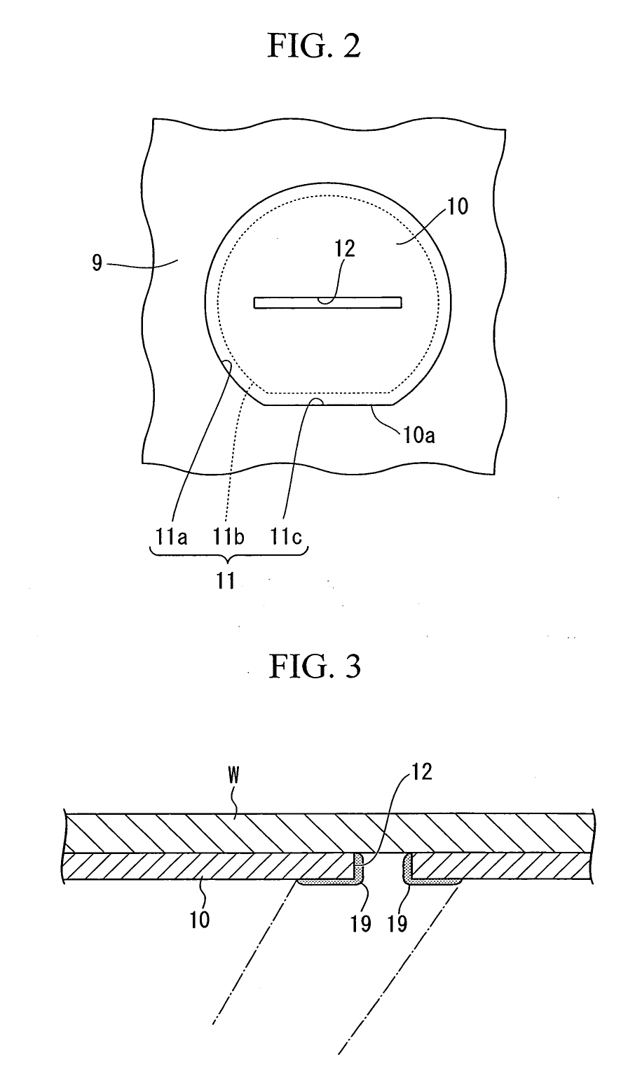

An elongated opening 12 having a predetermined width is formed on the shielding plate 10 as shown in FIG. 2.

An extending direction of the opening 12 is orthogonally positioned to the direction for transporting the substrate W by properly arranging the shielding plate 10 relative to the substrate W. The opening 12 is used for the oriented film material sublimated from the evaporating section 7 so that the oriented film material is selectively evaporated on the substrate W.

Furthermore, the opening 12 is arranged so as to set an angle between the surface of the substrate W exposed by the opening 12 and a sublimating direction from the evaporation source 7a to the opening 12, in a predetermined angle range.

Hence, the sublimate (evaporant) of the oriented film material is obliquely evaporated at a predetermined angle to the film formation surface of the substrate W.

In this embodiment, an alignment section is formed between the holding section 11 and the shielding plate 10 so as to align the shielding plate 10 relative to the substrate W at a predetermined position. In other words, the opening 12 is set to a predetermined position relative to the evaporation source 7a by the alignment section.

The shielding plate 10 is substantially circularly shaped as shown in FIG. 2. An elongated portion 10a is formed on an outer-periphery of the shielding plate 10 and is positioned parallel relative to the opening 12.

On the other hand, an elongated portion 11c is formed on an inner-periphery of the opening 11a holding the shielding plate 10 and corresponds to the elongated portion 10a.

In this composition, the shielding plate 10 is held and fixed on the holding section 11 while bringing the elongated portion 10a into contact with the elongated portion 11c of the holding section 11, as shown in FIG. 2.

Thus, in this embodiment, the alignment section is provided by the elongated portion 10a of the shielding plate 10 and the elongated portion 11c of the holding section 11.

In addition, not only the composition including the elongated portions 10a and 11c but also an alignment section having a joint known in prior art such a joint having a shape other than the elongated portions 10a and 11c, a joint having composition by which a pin is inserted to an opening or the like, may be adopted as the alignment section in this invention.

Furthermore, the shielding plate 10 covers a non-oriented film formation area other than the film formation area prescribed by the opening 12 by covering the bottom surface side of the substrate W.

However, since the substrate W moves onto the opening 12, the oriented film material can be obliquely evaporated over the film formation area by placing the entire film formation area (oriented film formation area) of the substrate W over the opening 12.

In the film formation chamber 2, in order to prevent the adherence of the oriented film material on the inner wall of the film formation chamber 2, adherent resistant plates 13 are removably arranged on the inner wall of the film formation chamber 2.

The transfer chamber 3 is connected and communicated to the film formation chamber 2 via a gate valve 14. The transfer chamber 3 is constituted as a vacuum chamber and is connected to a vacuum pump (not shown) for controlling the inner pressure thereof to obtain a desired vacuum, similarly the film formation chamber 2.

The gate valve 14 is openable and closable, and tightly isolates the film formation chamber 2 from the transfer chamber 3. The film formation chamber 2 communicates with the transfer chamber 3 when the gate valve 14 is opened.

The storing chamber 4 is connected and communicated to the transfer chamber 3 via a gate valve 15.

Unused shielding plates are stored in the storing chamber 4. The storing chamber 4 is constituted as a vacuum chamber, and is connected to a vacuum pump (not shown) for controlling the inner pressure thereof to obtain a desired vacuum state, similar to the film formation chamber 2 and transfer chamber 3.

The gate valve 15 is openable and closable, and tightly isolates the transfer chamber 3 from the storing chamber 4. The transfer chamber 3 communicates with the storing chamber 4 when the gate valve 15 is opened.

A cassette elevating device 16 is connected to the storing chamber 4 and is connected to a storing cassette 17 arranged in the storing chamber 4. The cassette elevating device 16 is an elevating device commonly known such as an air cylinder, hydraulic cylinder, or the like. The cassette elevating device 16 includes an elevating rod and a supporting plate (not shown) arranged on the elevating rod, and attachably/detachably holds the storing cassette 17 on the supporting plate.

The unused shielding plates including reserved shielding plates, the shielding plates which have been cleaned, or the shielding plates on which oriented film material is not adhered, are stored in the storing chamber 4.

A maintenance gate valve (not shown) used for changing of the storing cassette 17 is connected to the storing chamber 4, is different from the gate valve 15, and can communicate to the outside.

When all unused shielding plates are substituted to shielding plates which. have been used for evaporation, this maintenance gate valve is opened, and the storing cassette 17 storing the used shielding plates is substituted to a storing cassette 17 prepared in separately.

A substituting device 18 is arranged in the transfer chamber 3 and substitutes the shielding plate 10 arranged in the film formation chamber 2 to the unused shielding plate 10 stored in the storing chamber 4.

The substituting device 18 is arranged in the transfer chamber 3 and includes a moving section 18a and an arm mechanism 18b. The moving section 18a runs between the film formation chamber 2 and the storing chamber 4. Thus the moving section 18a runs between the gate valve 14 and 15. The arm mechanism 18b is rotatably, elevatably, and lowerably connected relative to the moving section 18a and includes arms, gears and a chucking portion (not shown). In the arm mechanism 18b, the chucking portion such as an electrostatic chuck, a magnetic chuck, or the like is formed on an end portion of the arm and can hold the shielding plate 10. The arm mechanism 18b operates extendable or retractable, while holding the shielding plate 10. Thereby, the shielding plate 10 is moved forward or backward by the arm mechanism 18b. In the substituting device 18 including such composition, the moving section 18a is moved toward the gate valve 14 or 15, the shielding plate 10 is held by operation of the arm mechanism 18b, and the shielding plates 10 are transferred.

Next, the manufacturing method for the oriented film by the manufacturing apparatus 1 and maintenance for the manufacturing apparatus 1 are described.

First, the gate valve 14 is closed, the inside of the film formation chamber 2 is regulated to a vacuum by operating the vacuum pump 5, and the inside of the film formation chamber 2 is regulated to a desired temperature by a heater (not shown).

In addition, as a separate operation, the evaporation source 7a is covered by the shutter 8, the evaporation source 7a is operated to sublimate and deposit an oriented film material in this state.

Subsequently, if the sublimation rate of the evaporation source 7a is stabilized, the shutter 8 is opened by moving the shutter 8. Thereby the evaporation source 7a is opened.

When opening the evaporation source 7a, it is possible to sublimate and deposit the inorganic material in an area shown by a double chain line in FIG. 1.

Successively, the substrate W on which pretreatment (e.g., heating treatment or the like) has been applied is transferred into the film formation chamber 2.

Then, the transporting section continuously or intermittently transports the substrates W, the substrate W is reached on the shielding plate 10, and film forming surface of the substrate W is exposed via the opening 12 while moving the substrate W.

In this case, since the opening 12 is arranged so as to set an angle between the surface of the substrate W exposed by the opening 12 and a sublimating direction from the evaporation source 7a to the opening 12 in a predetermined angle range, the oriented film material sublimated from the evaporation source 7a is obliquely evaporated at a predetermined angle to the film forming surface of the substrate W.

Then, the oriented film material can be obliquely evaporated over the surface of the film formation area (oriented film formation area) of the substrate W and a desired oriented film can be formed by performing such an oblique evaporation while continuously or intermittently moving the substrate W relative to the opening 12.

However, in the forming of the oriented film by such oblique evaporation, it is almost impossible to selectively sublimate and deposit the evaporant to only the opening 12. The oriented film material 19 is generally adhered in the vicinity of the opening 12 at the bottom face of the shielding plate 10, also to the inner-edge of the opening 12, as shown in FIG. 3.

Then, the amount of adherence of the oriented film material 19 increases depending on how long the evaporation is performed. There is concern that the film performance such as the orientation control function may degrade because of the adhered oriented film material 19.

Accordingly, in this invention, the shielding plates 10 are also substituted for maintenance, in order to prevent the degradation of the film performance such as the orientation control function.

However, this invention is different from the prior art in that it is not necessary to revert the pressure of the film formation chamber 2 to atmospheric pressure because the shielding plate 10 is automatically substituted by the substituting device 18 without changing the pressure.

In this embodiment of the invention, after forming the oriented film on the substrate W, the pressure inside the film formation chamber 2 is not reverted to atmospheric pressure, the substrate W is transferred to the post-processing chamber, and the sublimation of the oriented film material by the evaporating section 7 stops.

In addition, the inner pressure of the transfer chamber 3 and the inner pressure of the storing chamber 4 are set in a vacuum before performing maintenance (substituting of the shielding plates).

With regard to the timing of the maintenance (the substituting of the shielding plates), the timing is not limited. For example, after each time the evaporation is performed to one substrate W or after each time the evaporation is performed to a predetermined number of substrate W, the substituting of the shielding plate 10 may be performed.

After each substitute, the gate valve 14 is opened, and the moving section 18a of the substituting device 18 is moved toward a side of the gate valve 14.

Then, the shielding plate 10 is removed from the holding section 11 in the film formation chamber 2, the chucking portion holds the shielding plate 10, the shielding plate 10 is transferred from the film formation chamber 2 into the transfer chamber 3 while holding the shielding plate 10 by operating the arm mechanism 18b.

The arm mechanism 18b is rotated relative to the moving section 18a, the shielding plate 10 held by the arm mechanism 18b is turned toward the storing chamber 4, and the moving section 18a is moved toward a side of the gate valve 15.

After each operation, the gate valve 15 is opened, and the arm mechanism 18b inserts the used shielding plate 10 held thereby to the storing cassette 17. Furthermore, the arm mechanism 18b takes the unused shielding plate 10 from the storing cassette 17 and holds it.

Then, the arm mechanism 18b is rotated relative to the moving section 18a, the unused shielding plate 10 held by the arm mechanism 18b is turned toward the film formation chamber 2, the moving section 18a is moved toward a side of the gate valve 14, and the unused shielding plate 10 is fit into the holding section 11.

Then, since the alignment section is formed between the holding section 11 and the shielding plate 10 by the elongated portions 10a and 11c as described above, it is possible to align the opening 12 of the shielding plate 10 at a predetermined position by fitting the shielding plate 10 into the opening 1a of the holding section 11 at the position regulated by the alignment section.

After the substituting of the shielding plate 10, the gate valve 14 is closed, and the substrate W is evaporated by using the unused shielding plate 10 substituted by the substituting device 18.

In addition, when such substituting of the shielding plate 10 is repeated, and when all shielding plates 10 stored in the storing cassette 17 have been substituted with the used shielding plates 10, the gate valve 15 is closed and the inner pressure of the storing chamber 4 is reverted to atmospheric pressure.

Then, the maintenance gate valve (not shown) which can communicate to the outside and which is different from the gate valve 15 is opened, and the storing cassette 17 in which the used shielding plates 10 are stored to the storing cassette 17 prepared separately in which the unused shielding plates 10 are stored.

After substituting of the storing cassette 17, the maintenance gate valve which can communicate to the outside is closed, the inner pressure of the storing chamber 4 is reverted to the vacuum, and this state is held.

With regard to the transfer chamber 3 and the storing chamber 4, the gate valve 15 is arranged therebetween, so that the transfer chamber 3 and the storing chamber 4 are each independent of the vacuum chamber in this embodiment. A single chamber including the transfer chamber 3 and the storing chamber 4, in which the transfer chamber 3 and the storing chamber 4 are communicated without the gate valve 15 may be also adopted.

Also in this composition, since a vacuum state of the inner film formation chamber 2 is controlled by opening and closing the gate valve 14, it is possible to substitute the shielding plate 10 without greatly lowering the vacuum in the film formation chamber 2.

According to the constituted manufacturing apparatus 1, it is possible to substitute the shielding plate 10 with the unused shielding plate 10 by the substituting device 18 and by adjusting the pressure of the transfer chamber 3 in the vacuum while maintaining the pressure of the film formation chamber 2 in the vacuum, when maintenance is performed, for example, after evaporation is performed in a predetermined period.

Therefore, it is possible to reset the evaporating condition to an initial evaporating condition by substituting the shielding plate with the new shielding plate 10, and to prevent the degradation of the film performance such as the orientation control function of the oriented film.

Furthermore, it is possible to prevent the occurrence of evaporation irregularities such as line-like marks or the like that are formed on the manufactured oriented film due to the influence of the oriented film material adhered to the shielding plate 10. In addition, it is possible to also prevent the adhering of floatable particles adhered on the shielding plate 10 to the oriented film.

Thus, the degradation of the film performance such as the orientation control function of the manufactured oriented film can be prevented.

In the above-described maintenance, since the substituting of the shielding plate 10 can be performed while maintaining the inside of the film formation chamber 2 in a vacuum state, it is possible to omit the operation of reverting the pressure inside the film formation chamber 2 from the vacuum to the atmospheric pressure, and next adjusting the pressure from the atmospheric pressure to the vacuum.

Therefore, it is possible to remarkably improve productivity by avoiding the operation of reverting the pressure in the vacuum.

The invention is not limited to this embodiment, and various modifications are possible to an extent that does not deviate from scope of the invention.

A single substituting device 18 is arranged in the transfer chamber 3 in the above described embodiment, for example, a plurality of the substituting devices 18 may be arranged in the transfer chamber 3.

Specifically, two substituting devices 18, for example, a first substituting device and a second substituting device are arranged in the transfer chamber 3, the first substituting device is used for an exclusive substituting device which discharges the shielding plate 10 from the film formation chamber 2 to the storing chamber 4, and the second substituting device is used for an exclusive substituting device which supplies the unused shielding plate 10 from the storing chamber 4 to the film formation chamber 2. In this case, a discharging arm mechanism is arranged as the first substituting device, and a supplying arm mechanism is arranged as the second substituting device.

In this composition, since it is possible to perform the discharging of the used shielding plate 10 from the film formation chamber 2 to the storing chamber 4, and the supplying of the unused shielding plate 10 from the storing chamber 4 to the film formation chamber 2 in parallel, the time needed for the substituting of the shielding plate 10 can be shortened. Thus, productivity can be remarkably improved.

Furthermore, two arm mechanisms, for example, a first arm mechanism and a second arm mechanism may be arranged in place of the single substituting device 18. In this case, the first arm mechanism is used as an arm mechanism for discharging the shielding plate 10 and the second arm mechanism is used as an arm mechanism for supplying the shielding plate 10.

Furthermore, a plurality of the transfer chambers 3 and a plurality of the storing chambers 4 may be connected relative to a single film formation chamber 2. In this case, the substituting device 18 described above may be arranged in each of the transfer chambers 3, and a single substituting device may be arranged relative to the transfer chambers 3.

Specifically, a first transfer chamber includes an exclusive discharging arm mechanism discharging the shielding plates from the film formation chamber 2 to the storing chamber 4, and a second transfer chamber includes an exclusive supplying arm mechanism supplying the unused shielding plates from the storing chamber 4 to the film formation chamber 2.

In this composition, a single substituting device including the discharging arm mechanism and the supplying arm mechanism can be arranged in the transfer chamber. Therefore, the used shielding plates 10 are discharged from the film formation chamber 2 to the storing chamber 4 in the first transfer chamber, and the unused shielding plates 10 are supplied from the storing chamber 4 to the film formation chamber 2 in the second transfer chamber in parallel. Thus, productivity can be remarkably improved.

In addition, in the case in which the substrates W are evaporated by using the shielding plates 10 in the film formation chamber 2, if the transfer chambers 3 and the storing chambers 4 are connected relative to the film formation chamber 2, it is possible to simultaneously substitute the shielding plates 10.

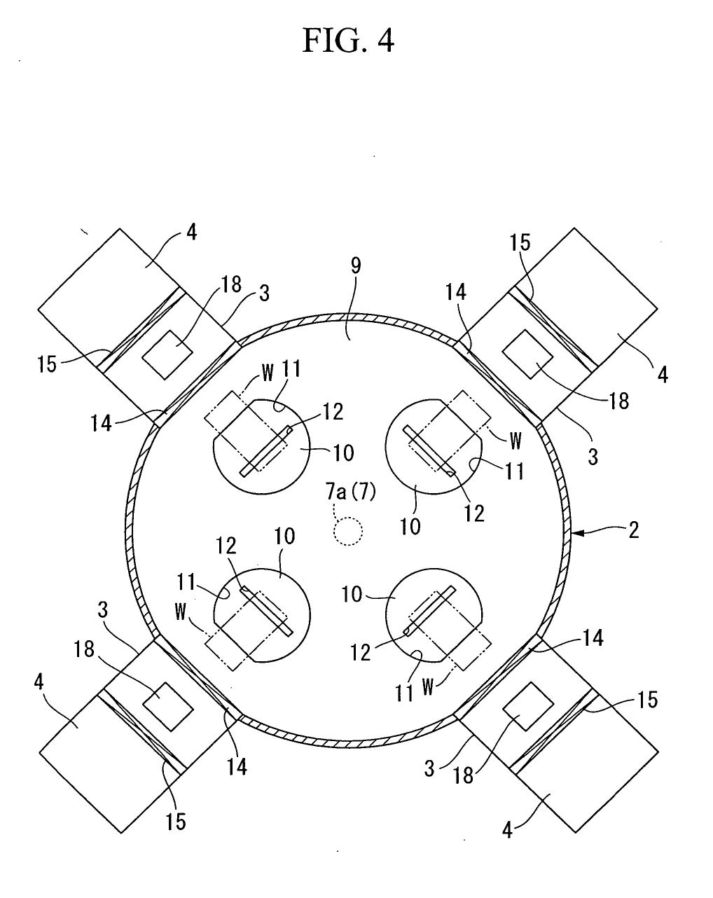

FIG. 4 is a schematic plan view of the manufacturing apparatus including the shielding plates 10. In this manufacturing apparatus, the evaporation source 7a (evaporating section 7) is arranged at the center of the film formation chamber 2 circularly shaped as shown in FIG. 4, and the shielding plates 10 are arranged spokewise relative to the evaporation source 7a.

Specifically, the holding plate 9 arranged at an upper portion of the evaporation source 7a as shown in FIG. 1. Four holding sections 11 are formed on the holding plate 9 at outer positions and at regular intervals. The shielding plate 10 is held in each of the holding sections 11.

In addition, the transfer chamber 3 and the storing chamber 4 are connected to the outside of the film formation chamber 2 and correspond to each holding section 11.

The substituting device 18 is arranged in each transfer chamber 3.

In arranging the shielding plates 10 (four shielding plates), it is possible to form the oriented film by the oblique evaporation onto the substrates W differently from each other and by using each shielding plate 10.

Specifically, since the opening 12 is arranged so as to set an angle between the surface of the substrate W exposed by the opening 12 and a sublimating direction from the evaporation source 7a to the opening 12 in a predetermined angle range, the oriented film material sublimated from the evaporation source 7a is obliquely evaporated at a predetermined angle to the film forming surface of the substrate W. In addition, the oblique evaporation is performed to the substrates W from the single evaporation source 7a at the same incidence angle. Furthermore, it is possible to simultaneously form the oriented film on each of the four substrates W in the film formation chamber 2.

Thus, productivity can be remarkably improved.

In addition, by using the transfer chamber 3, the storing chamber 4, and the substituting device 18 to which each holding section 11 corresponds, it is possible to simultaneously substitute the shielding plates held by the holding section 11 when maintenance is performed. Thus, productivity can be remarkably improved.

In addition, in the manufacturing apparatus for manufacturing an oriented film, it is preferable to substitute the shutter 8 covering the evaporation source 7a with a new shutter 8, after the forming of the film has been performed during a predetermined period.

With respect to the shutter 8, the amount of the adherence of the oriented film material to the shutter 8 increases when using the shutter for a long time, so there is concern that adherent evaporants become floatable particles and adhere to the oriented film. Accordingly, similar to the case of the substitute and the transport of the shielding plate 10, it is preferable that a substituting mechanism for substituting the shutter 8 include: a transfer chamber 20 which is similar to the transfer chamber 3; a shutter storing chamber 21 which is similar to the storing chamber 4; and a substituting device 18, where the substituting of the shutter 8 is automatically performed without changing the vacuum state of the film formation chamber 2 as shown by a double chain line in FIG. 1.

Next, a liquid crystal device of this invention provided with the oriented film formed by the manufacturing method based on such manufacturing apparatus 1 is described.

The scale of members is suitably changed to make the members recognizable sizes in the drawings used in the following description.

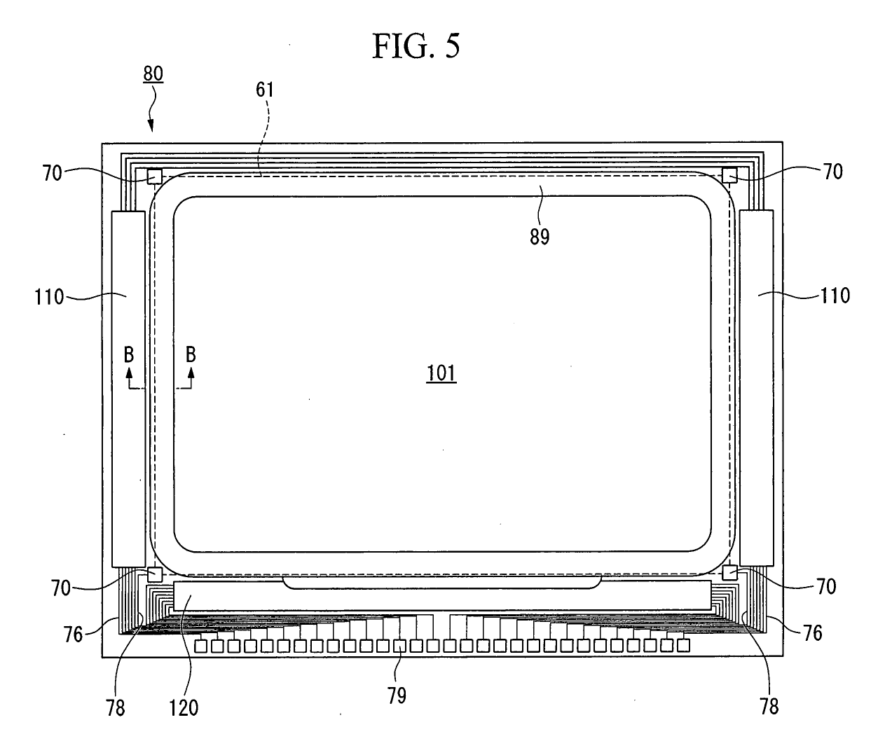

FIG. 5 is a plan view of a TFT array substrate showing a schematic constitution of an embodiment of the liquid crystal device of this invention.

Reference numeral 80 is the TFT array substrate in FIG. 5.

An image forming area 101 is formed at the center of the TFT array substrate 80.

A sealant 89 is arranged at the periphery of the image forming area 101, and a liquid crystal layer (not shown) is sealed in the image forming area 101.

The liquid crystal layer is formed by directly applying a liquid crystal onto the TFT array substrate 80, becoming a so-called seal-less structure in which an injection port of liquid crystal is not provided for the sealant 89.

Scanning line driving elements 110 for supplying a scanning signal to scanning lines described later and a data line driving element 120 for supplying an image signal to data lines described later are mounted to the outer side of the sealant 89.

Wirings 76 are drawn around from the driving elements 110 and 120 to connection terminals 79 of the end of the TFT array substrate 80.

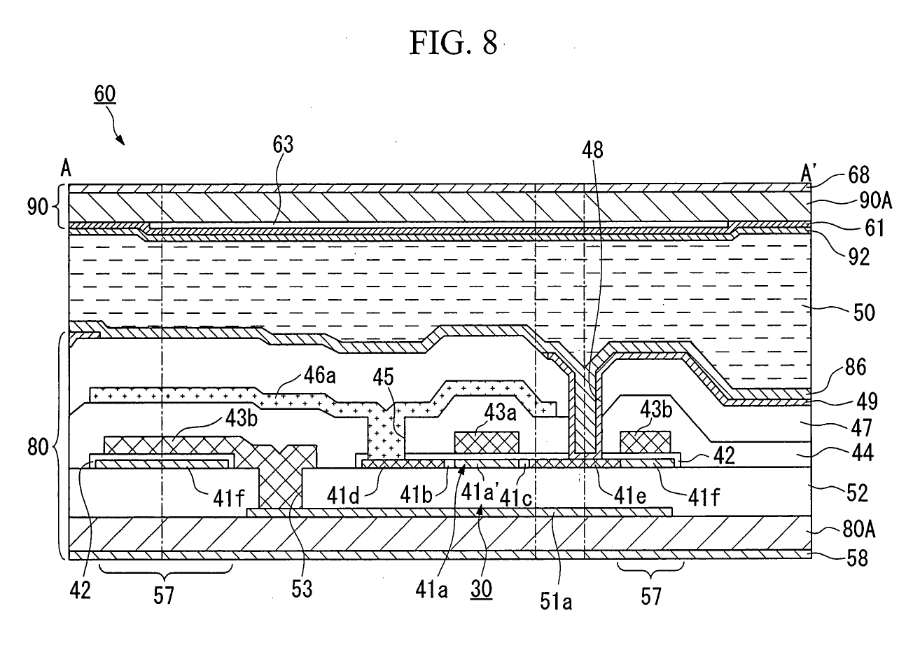

On the other hand, a common electrode 61 (show in FIG. 8) is formed on a facing substrate 90.

This common electrode 61 is formed over nearly the entire image forming area 101, and conducting parts 70 between substrates 80 and 90 are formed at four corners thereof.

Wirings 78 are drawn from conduction parts 70 between substrates 80 and 90 to the connection terminals 79.

Then, the liquid crystal device is driven by supplying various signals input from the outside to the image forming area 101 via the connection terminals 79.

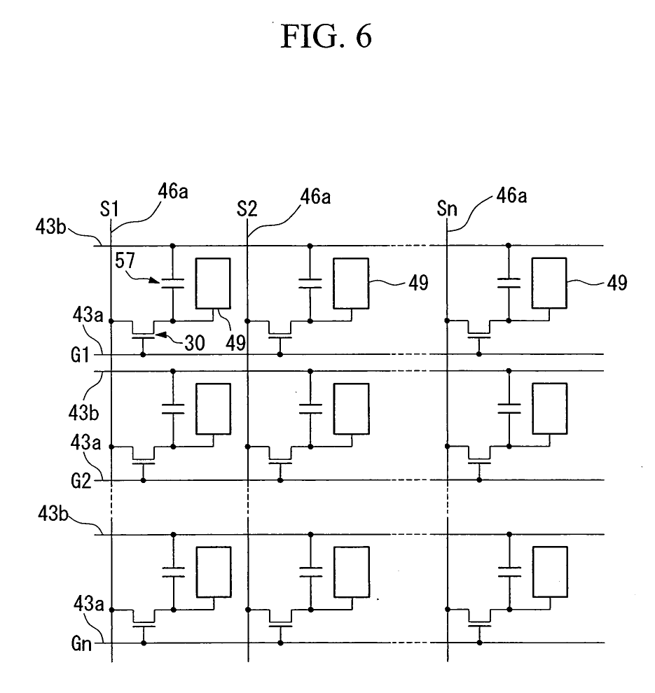

FIG. 6 is an equivalent circuit of the liquid crystal device.

Each of pixel electrodes 49 is formed in each of plurality of image elements arranged in an arrayed arrangement (matrix arrangement) which construct the image forming area 101 of a transmission-type liquid crystal device.

Moreover, TFT elements 30 including switch elements for performing control of energization of the pixel electrodes 49 are formed on the side portion of the pixel electrodes 49.

Data lines 46a are connected to sources of these TFT elements 30.

Image signals S1, S2, - - - , Sn are supplied from the above-mentioned data line driving element 120 to the each of data lines 46a.

Scanning lines 43a are connected to gates of the TFT elements 30.

Scanning signals G1, G2, - - - , Gm are supplied from the above-mentioned scanning line driving elements 110 to the each of scanning lines 43a in pulses at a predetermined timing.

On the other hand, the pixel electrodes 49 are connected to drains the of TFT elements 30.

If the TFT elements 30 including switch elements are turned ON only in a given period, the image signals S1, S2, - - - , Sn supplied from the data lines 46a are written in the liquid crystal of image elements at a predetermined timing via the pixel electrodes 49 by the scanning signals G1, G2, - - - , Gm supplied from the scanning lines 43a.

The image signals S1, S2, - - - , Sn at a predetermined level written in the liquid crystal are held for a given period by liquid crystal capacities formed between the pixel electrodes 49 and the common electrode 61 described later.

Accumulative capacities 57 are formed between the pixel electrodes 49 and capacity lines 43b and are arranged in parallel to the liquid crystal capacities to prevent the held image signals S1, S2, - - - , Sn from leakage.

Thus, if a voltage signal is applied on the liquid crystal, the oriented state of liquid crystal molecules changes with the applied voltage level.

Thereby, light of the light source entering the liquid crystal is modulated to prepare light of an image.

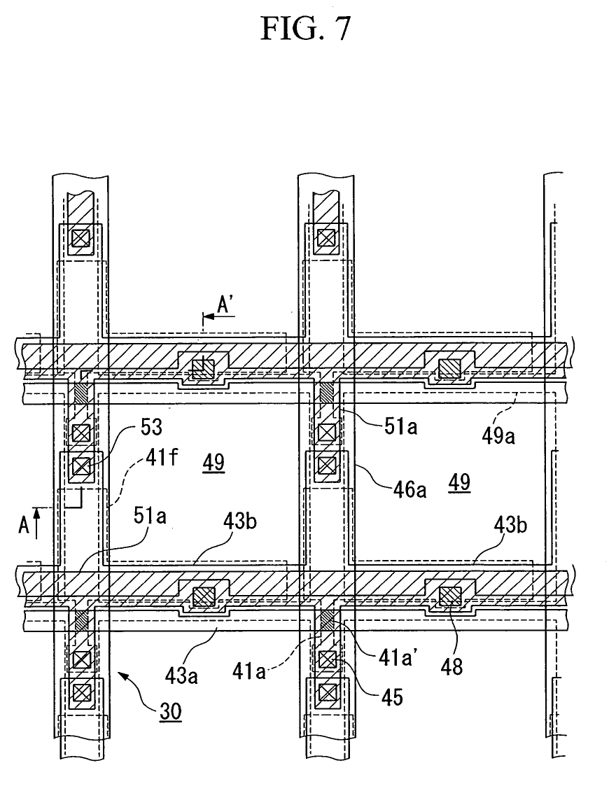

FIG. 7 is a plan view of the planar structure of the liquid crystal device.

In the liquid crystal device of this embodiment, rectangular pixel electrodes 49 (their contours are shown by broken lines 49a) made of a transparent conductive material, such as Indium Tin Oxide (called ITO hereafter), are arrayed in an arrayed arrangement (matrix arrangement) on a TFT array substrate.

The data lines 46a, scanning lines 43a and capacity lines 43b are provided along vertical and horizontal boundaries of the pixel electrodes 49.

In this embodiment, the rectangular area formed with the pixel electrodes 49 includes image elements and becomes a structure capable of performing a display for each dot arranged in an arrayed arrangement.

The TFT elements 30 are formed with a semiconductor layer 41a made of a polysilicon film, etc. as the center.

The data lines 46a are connected to a drain region (described later) of the semiconductor layer 41a via connector holes 45.

The pixel electrodes 49 are connected to a source region (described later) of the semiconductor layer 41 a via connector holes 48.

On the other hand, a channel region 41a′ is formed in a section faced to the scanning line 43a in the semiconductor layer 41a.

FIG. 8 is a cross-sectional view of a sectional structure of the liquid crystal device and is a cross-sectional view at an arrow line A-A′ of FIG. 7.

As shown in FIG. 8, a liquid crystal device 60 of this embodiment is provided with a TFT array substrate 80, a facing substrate 90 arranged faced to the TFT array substrate 80, and a liquid crystal layer 50 held between the substrates 80 and 90 as the main body.

The TFT array substrate 80 is provided with the substrate body 80A made of a translucent material such as glass or quartz, the TFT element 30, the pixel electrode 49 formed at an inner side of the substrate body 80A, the inorganic oriented film 86, etc. as the main body.

On the other hand, the facing substrate 90 is provided with a substrate body 90A made of a translucent material such as glass or quartz, the common electrode 61 formed at an inner side of the substrate body 90A, the inorganic oriented film 92, etc. as main body.

A first shading film 51la and a first interlayer insulating film 52 described later are formed at the surface of the TFT array substrate 80.

Then, the semiconductor layer 41 a is formed on the surface of the first interlayer insulating film 52, and the TFT element 30 is formed with this semiconductor layer 41a as the center.

The channel region 41a′ is formed in a portion faced to the scanning line 43a at the semiconductor layer 41a, and a source region and a drain region are formed at both sides of the semiconductor layer 41a.

An LDD (Lightly-Doped Drain) structure is adopted in the TFT element 30, therefore a high-concentration region with a relatively high impurity concentration and a low-concentration region with a relatively low impurity concentration (LDD region) are formed in the source region and the drain region, respectively.

Therefore, a low-concentration source region 41b and a high-concentration source region 41d are formed in the source region, and a low-concentration drain region 41c and a high-concentration drain region 41e are formed in the drain region.

A gate insulating film 42 is formed on the surface of the semiconductor layer 41a.

Then, the scanning line 43a is formed on the surface of the gate insulating film 42, and a portion faced to the channel region 41a′ is a gate electrode.

A second interlayer insulating film 44 is formed on the surface of the gate insulating film 42 and the scanning line 43a.

Then, the data line 46a is formed on the surface of the second interlayer insulating film 44, and the data line 46a is connected to the high-concentration source region 41d via a connection hole 45 formed on the second interlayer insulating film 44.

A third interlayer insulating film 47 is formed on the surface of the second interlayer insulating film 44 and on the data line 46a.

Then, the pixel electrode 49 is formed on the surface of the third interlayer insulating film 47, and the pixel electrodes 49 are connected to the high-concentration drain region 41d via a connection hole 48 formed in the second interlayer insulating film 44 and the third interlayer insulating film 47.

Moreover, the inorganic oriented film 86 covering the pixel electrode 49 and formed by the manufacturing apparatus 1 is formed on the pixel electrode 49, and can control the orientation of the liquid crystal molecules when applying a non-selective voltage.

In this embodiment, the semiconductor layer 41a is extended to form a first accumulative capacity electrode 41f.

The gate insulating film 42 is extended to form a dielectric film, and the capacity line 43b is arranged on the surface of the dielectric film to form a second accumulative capacity electrode.

The above-mentioned accumulative capacity 57 is constructed by the first accumulative capacity electrode 41f, the second accumulative capacity electrode (capacity line 43b), and the dielectric film (gate insulating film 42).

Furthermore, the first shading film 51a is formed on the surface of the substrate body 80A corresponding to a region forming the TFT element 30.

The first shading film 51a prevents light entering the liquid crystal device from entering into the channel region 41a′, low-concentration source region 41b and low-concentration drain region 41c of the semiconductor layer 41a, etc.

On the other hand, a second shading film 63 is formed on the surface of the substrate body 90A in the facing substrate 90.

The second shading film 63 prevents light entering the liquid crystal device from entering into the channel region 41a′, low-concentration source region 41b and low-concentration drain region 41c of the semiconductor layer 41a, etc., and is provided in a region overlapping with the semiconductor layer 41a in the plan view.

A common electrode 61 made of conductors such as ITO, etc. is formed over nearly the entire surface of the facing substrate 90.

Furthermore, an inorganic oriented film 92 formed by the manufacturing apparatus 1 is formed on the surface of the common electrode 61 and can control the orientation of liquid crystal molecules when applying a non-selective voltage.

Then, the liquid crystal layer 50 including of a nematic liquid crystal, etc. is held between the TFT array substrate 80 and the facing substrate 90.

These nematic liquid crystal molecules have a positive dielectric constant anisotropy, horizontally oriented along the substrate when applying a non-selective voltage, and vertically oriented along the direction of electric field when applying a selective voltage.

The nematic liquid crystal molecules have a positive index of refraction constant anisotropy, and a product of its birefringence and thickness of liquid crystal layer (retardation) Δnd becomes, e.g., about 0.40 μm (at 60° C.).

The direction of orientation control based on the oriented film 86 of the TFT array substrate 80 and the direction of orientation control based on the oriented film 92 of the facing substrate 90 are set to a twisted state of about 90°.

Thereby, the liquid crystal device 60 of this embodiment is operated by a twisted nematic mode.

Polarizing plates 58 and 68 made of a material from doping iodine in polyvinyl alcohol (PVA), etc. are arranged at the outside of the two substrates 80 and 90.

It is desirable that the polarizing plates 58 and 68 be mounted on a support substrate made of a high-thermal conductivity material, such as sapphire glass or quartz, etc., and arranged apart from the liquid crystal device 60.

The polarizing plates 58 and 68 absorb linear polarization in the direction of its absorption axis and have a function of transmitting the linear polarization in the direction of its transmission axis.

The polarizing plate 58 arranged at the TFT array substrate 80 is so arranged so that its transmission axis is in substantially conformity to the direction of orientation control of the oriented film 86, and the polarizing plate 68 arranged at the facing substrate 90 is so arranged that its transmission axis is in substantially conformity to the direction of orientation control of the oriented film 92.

In the liquid crystal device 60, an outside of the facing substrate 90 is faced to the light source.

Only the linear polarization in conformity with the transmission axis of the polarizing plate 68 in the light of the light source transmits through the polarizing plate 68 and enters the liquid crystal device 60.

In the liquid crystal device 60 during the application of a non-selective voltage, the liquid crystal molecules oriented horizontally to the substrate are laminated and arranged in the form of a twisted helix of approximately 90° to the thickness direction of liquid crystal layer 50.

Therefore, the linear polarized light entering the liquid crystal device 60 exits the liquid crystal device 60 with a rotation of approximately 90°.

The linear polarized light transmits through the polarizing plate 58 because it is in conformity with the transmission axis of polarizing plate 58.

Accordingly, a white display is performed in the liquid crystal device 60 during the application of a non-selective voltage (normally white mode).

In the liquid crystal device 60 during the application of a selective voltage, the liquid crystal molecules are oriented vertically to the substrate.

Therefore, the linear polarized light entering the liquid crystal device 60 exits from the liquid crystal device 60 without rotation.

The linear polarized light does not transmit through the polarizing plate 58 because it is perpendicular to the transmission axis of polarizing plate 58.

Accordingly, a black display is performed in the liquid crystal device 60 during the application of a selective voltage.

Here, the inorganic oriented films 86 and 92 formed by the manufacturing apparatus 1 are formed on the inner side of both substrates 80 and 90 as described above.

The inorganic oriented films 86 and 92 are suitably made of silicon oxide such as SiO₂ or SiO as described above, but they may also be made of metal oxides such as Al₂O₃, ZnO, MgO or ITO, etc.

In the liquid crystal device 60 having such inorganic oriented films 86 and 92, since it is possible to prevent the degradation of the film performance of the oriented 25 films 86 and 92 formed by the manufacturing apparatus 1 as described above, the liquid crystal device 60 itself also has desirable qualities.

Furthermore, since productivity of manufacturing the oriented films 86 and 92 can be improved, productivity of manufacturing the liquid crystal device 60 can be also improved.

Projector

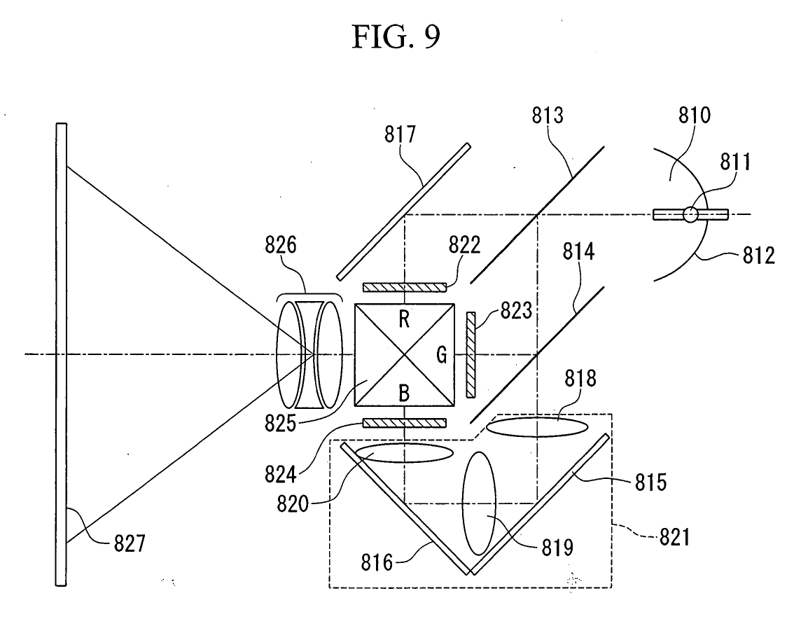

An embodiment of a projector as the electronic device of this invention is described hereafter with reference to FIG. 9.

FIG. 9 is a schematic block diagram showing the projector.

The projector is provided with the liquid crystal device relating to aforesaid embodiment as a photo-modulation section.

In FIG. 9, reference numeral 810 is a light source, reference numerals 813 and 814 are dichromic mirrors, reference numerals 815, 816 and 817 are reflecting mirrors, reference numeral 818 is an entrance lens, reference numeral 819 is a relay lens, reference numeral 829 is an exit lens, reference numerals 822, 823 and 824 are photo-modulation section consisting of the liquid crystal device of invention, reference numeral 825 is a cross dichromic prism, and reference numeral 826 is a projection lens.

The light source 810 includes a lamp 811 such as a metal halide lamp, etc. and a reflector 812 for reflecting light of the lamp.

The dichromic mirror 813 transmits red light contained in white light radiated from the light source 810 and reflects blue light and green light.

The transmitted red light is reflected by the reflecting mirror 817 and enters the photo-modulation section 822 for red light.

The green light reflected by the dichromic mirror 813 is reflected by the dichromic mirror 814 and enters the photo-modulation section 823 for green light.

The blue light is reflected by the dichromic mirror 813 and transmited through the dichromic mirror 814.

A light-guiding section 821 provided with a relay lens system including the entrance lens 818, relay lens 819 and exit lens 820 is provided to prevent light loss due to a long optical path for blue light.

The blue light enters the photo-modulation section 824 for blue light.

The three color lights modulated by the photo-modulation section 822, 823 and 824 enter the cross dichromatic prism 825.

The cross dichromic prism 825 is formed by pasting four right-angle prisms.

A dielectric multi-layer film for reflecting red light and a dielectric multi-layer film for reflecting blue light are formed in the shape of X and on a boundary face of the prisms.

The three color lights are synthesized by the dielectric multi-layer films to form light expressing a color image.

The synthesized light is projected on a screen 827 by a projection lens 826 including the projection optical system.

The above-mentioned projector is provided with a liquid crystal device as the photo-modulation section.

The liquid crystal device is provided with inorganic oriented films excellent in light resistance and heat resistance as described above.

Therefore, the oriented films do not deteriorate due to strong light radiated from a light source or heat.

The liquid crystal device has desirable qualities and improved productivity, therefore the projector (electronic device) itself also has desirable qualities and improved productivity.

The technical scope of invention is not limited to the above-mentioned embodiment, and embodiments added with various modifications to the above-mentioned embodiment are also included within parameters which do not deviate from the purpose of the invention.

For example, the liquid crystal device provided with TFT as switching elements was described as an example in the embodiment, but this invention is also applied to a liquid crystal device provided with two-terminal elements, such as thin film diodes, etc. as switching elements.

A transmission-type liquid crystal device was described as an example in the embodiment, but it is also possible to apply this invention to a reflection-type liquid crystal device.

A liquid crystal device functioning by TN (Twisted Nematic) mode was described as an example in the embodiment, but it is also possible to apply this invention to a liquid crystal device functioning by VA (Vertical Alignment) mode.

A three-plate type projection display device was described as an example in the embodiment, but it is also possible to apply this invention to a single-plate type projection display device or a direct-view display device.

It is also possible to apply this invention to electronic devices other than the projector.

A portable telephone can be given as a specific example thereof.

The portable telephone is provided with a liquid crystal device relating to the above-mentioned embodiments or their modified examples in the display unit. As other electronic device, for example, IC card, video camera, PC computer, head-mount display, moreover, fax device with display function, finder of a digital camera, portable TV, DSP device, PDA, electronic notebook, electric light notice board, display for propagation and announcement, etc. are given.

What is claimed is:

1. A manufacturing apparatus for manufacturing an oriented film of a liquid crystal device holding a liquid crystal between a pair of substrates facing each other, comprising:
a film formation chamber constituted as a vacuum chamber;
an evaporation section having an evaporation source, evaporating an oriented film material on the substrate by a physical vapor deposition, and forming the oriented film in the film formation chamber;
a shielding plate arranged between the evaporation section and the substrate, having an elongated opening for selectively evaporating the oriented film material, and covering an area of the substrate on which the oriented film is not formed;
a transfer chamber constituted as a vacuum chamber and connected to the film formation chamber via a gate valve;
a storing chamber connected to the transfer chamber and storing an unused shielding plate; and
a substituting device arranged in the transfer chamber and substituting the shielding plate arranged in the film formation chamber to the unused shielding plate stored in the storing chamber.

2. The manufacturing apparatus for manufacturing the oriented film, according to claim 1, wherein the storing chamber is connected to the transfer chamber via a gate valve.

3. The manufacturing apparatus for manufacturing the oriented film, according to claim 1, wherein the substituting device includes:
a discharging arm mechanism discharging the shielding plate from the film formation chamber to the storing chamber; and
a supplying arm mechanism supplying the unused shielding plate from the storing chamber to the film formation chamber.

4. The manufacturing apparatus for manufacturing the oriented film, according to claim 1, further comprising:
a plurality of the transfer chambers; and
a plurality of the storing chambers.

5. The manufacturing apparatus for manufacturing the oriented film, according to claim 1, wherein at least one of the substituting devices is arranged in the transfer chamber.

6. The manufacturing apparatus for manufacturing the oriented film, according to claim 1, wherein a plurality of the shielding plates is arranged in the film formation chamber.

7. The manufacturing apparatus for manufacturing the oriented film, according to claim 1, further comprising:
a holding section arranged in the film formation chamber and holding the shielding plate;
an alignment section arranged between the holding section and the shielding plate, and aligning the shielding plate so as to position the elongated opening of the shielding plate at a predetermined position.

8. The manufacturing apparatus for manufacturing the oriented film, according to claim 1, wherein the evaporation section has a shutter openably and closably covering the evaporation source.

9. A liquid crystal device comprising:
the oriented film manufactured by the manufacturing apparatus according to claim 1.

10. An electronic device comprising:
the liquid crystal device according to claim 9.
